(19) United States
(12) Patent Application Publication
(10) Pub. No.: US 2023/0146545 A1
(43) Pub. Date: May 11, 2023

(54) FLEXIBLE ARM FOR BATTERY RETENTION IN AN INFORMATION HANDLING SYSTEM

(71) Applicant: Dell Products, L.P., Round Rock, TX (US)

(72) Inventor: Derric Christopher Hobbs, (US)

(73) Assignee: Dell Products L.P., Round Rock, TX (US)

(21) Appl. No.: 17/454,342

(22) Filed: Nov. 10, 2021

(51) Int. Cl. H01M 50/262; H01M 50/284

(52) U.S. Cl. CPC H01M 50/262; H01M 50/284

(57) ABSTRACT

Securement of a battery module, such as a RTC battery and cable assembly, between a surface and mainboard of an information handling system can be provided by a battery module retention apparatus. This battery module retention apparatus can be integral to the surface and can comprise a flexible arm for securing the battery module between the surface and mainboard. The flexible arm of the battery module retention apparatus may be hingedly coupled to the surface and may be moveable between an open position in which a battery module can be inserted between the surface and mainboard and a closed position in which a battery module can be secured between the surface and mainboard. Use of such a battery module retention apparatus can reduce the materials needed for assembly of the information handling system, thereby improving manufacturing and serviceability efficiency of the information handling system.

### FIELD OF THE DISCLOSURE

The instant disclosure relates to information handling systems. More specifically, portions of this disclosure relate to a surface with a flexible arm to releasably secure a battery to the surface.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems (IHSs) are challenged every generation to incorporate more or larger components compared to generations prior into the same or smaller form-factors. However, this reduces space on the mainboard or in other spaces within information handling systems for components such as a battery and associated cable assembly.

### SUMMARY

A mechanism for securing a battery module to a surface may use existing surface materials to form a flexible arm feature hingedly connected to the surface to mechanically retain the battery module in the surface on which the mainboard of the IHS is mounted. With the flexible arm configured to move relative to a cavity of the surface, a method of releasably securing a battery module may include moving the flexible arm between an open position in which the battery module can be received by the cavity of the surface and a closed position in which the battery module is secured in the surface. The flexible arm may be biased toward the closed position to secure the battery module in the surface, and the surface may be configured to maintain the arm in the open position to allow for insertion of the battery module. For example, the surface may include, in addition to the flexible arm, a second arm having multiple recesses and/or protrusions such that the second arm is configured to engage and/or retain the flexible arm while in the open position.

In information handling systems according to embodiments of this disclosure, a battery module may refer to a battery, and in some embodiments certain components associated with the battery. For example, a battery module may include a CMOS battery. As another example, a battery module may include a RTC battery, which may include a battery attached to a cable with a covering, such as an acrylonitrile butadiene styrene (ABS) and/or polycarbonate plastic shell, around the battery and a portion of the cable to secure the battery to the cable.

A mechanism, such as described in embodiments herein, may reduce the space occupied by a battery in an information handling system, thus allowing for smaller form factor devices and/or inclusion of additional functionality within the information handling system. For example, retention clips and/or pressure sensitive adhesives (PSAs) are conventionally used for securing a battery and/or cable assembly to a surface on which a mainboard of an IHS is mounted. However, use of separate retention clips to secure the battery increases the volume consumed by the battery module and reduces space available for other components or functionality and increases the cost of materials associated with manufacture of the IHS, while use of PSAs impacts serviceability of the IHS by adding cleaning steps to remove old adhesives as part of replacement of the battery.

Shortcomings mentioned here are only representative and are included to highlight problems that the inventors have identified with respect to existing information handling systems and sought to improve upon. Aspects of the information handling systems described herein may address some or all of the shortcomings as well as others known in the art. Aspects of the improved information handling systems described below may present other benefits than, and be used in other applications than, those described above.

According to one embodiment, an apparatus for releasably securing a battery module between a surface and a mainboard of an information handling system may include a surface having at least one wall that defines a cavity configured to receive a battery module such that the wall overlies at least a portion of the battery module when the battery module is received in the cavity and a first arm opposite the cavity configured to releasably secure the battery module in the cavity, the first arm being movable between an open position in which a distance between the first arm and the cavity is larger than a distance between the first arm and the cavity when the first arm is in a closed position in which the battery module is secured in the cavity. The first arm, in some embodiments, is connected to the surface via a living hinge.

In certain embodiments, the first arm has a first end, a second end, and a middle portion between the first end and second end, and wherein: the first end hingedly couples the first arm to the surface; the middle portion is configured to retain the battery module; and the second end is configured to be manipulated by a user to transition the first arm between the open position and the closed position. In some embodiments, the middle portion of the first arm is configured to retain the battery module such that the first arm overlies at least a portion of the battery module when the first arm is in the closed position. In some embodiments, the middle portion of the first arm is arcuate. In certain embodiments, the first arm is laterally moveable relative to the wall between the open position and the closed position.

In certain embodiments, the first arm is biased toward the closed position, and in some embodiments, the surface is configured to maintain the first arm in the open position. The surface, in certain embodiments, further comprises a second arm opposite the cavity configured to engage and/or retain the second end of the first arm. The second arm, in some embodiments, is integrally connected to the surface and defines at least a first recess and a second recess, and wherein the at least first recess and second recess are separated by at least one protrusion. In certain embodiments, the at least one protrusion defines a ramp. In certain embodiments, the second end of the first arm is received in the first recess when the first arm is in the open position; and the second end of the first arm is received in the second recess when the first arm is in the closed position.

According to another embodiment, a method may include assembling an information handling system comprising a battery module and a battery module retention apparatus by moving the first arm of the battery module retention apparatus away from a cavity opposite the first arm into an open position via a living hinge connecting the first arm to a surface of the battery module retention apparatus, inserting the battery module into the cavity and allowing the first arm to return to a closed position via the living hinge.

In certain embodiments, the surface further comprises a second arm opposite the cavity for engaging and/or retaining a second end of the first arm, the second arm defining at least a first and second recess separated by at least one protrusion, the first recess configured to receive the second end of the first arm when the first arm is in the open position, and the second recess configured to receive the second end of the first arm when the first arm is in the closed position; and the method comprises moving the first arm into the open position by moving the second end of the first arm from the second recess over the protrusion such that the second end of the first arm is received by first recess, and moving the first arm into the closed position by moving the second end of the first arm from the first recess over the protrusion such that the second end of the first arm is received by second recess.

According to another embodiment, an information handling system, comprising a mainboard, a surface coupled to the mainboard, a battery module secured between the mainboard and surface, and a battery module retention apparatus for securement of the battery between the mainboard and the surface, comprising: a surface having at least one wall that defines a cavity configured to receive a battery module such that the wall overlies at least a portion of the battery module when the battery module is received in the cavity and a first arm opposite the cavity configured to releasably secure the battery module in the cavity, the first arm being movable relative to the wall between an open position in which the battery module is received by the cavity and a closed position in which the battery module is secured in the cavity, wherein the first arm is connected to the surface via a living hinge.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is schematic of a top profile view of an example of a surface having a battery module retention apparatus according to embodiments of the disclosure.

FIG. 2 is top profile view of a battery module retention apparatus according to embodiments of the disclosure.

FIG. 3 is a top view of a battery module retention apparatus having a battery module secured therein according to embodiments of the disclosure.

FIG. 4 is a sectional view of the FIG. 3 battery module retention apparatus taken along line 4-4 of FIG. 3 and illustrates securement of a battery module by the battery module retention apparatus.

FIG. 5 is a top view of a battery module retention apparatus according to embodiments of the disclosure and illustrates a first arm of the battery module retention apparatus in an open position.

FIG. 6 is a cross-sectional view of the FIG. 5 battery module retention apparatus taken along line 6-6 of FIG. 5 and illustrates a first arm of the battery module retention apparatus in an open position.

FIG. 7 is a top view of a battery module retention apparatus according to embodiments of the disclosure and illustrates a first arm of the battery module retention apparatus in a closed position.

FIG. 8 is a cross-sectional view of the FIG. 7 battery module retention apparatus taken along line 8-8 of FIG. 7 and illustrates a first arm of the battery module retention apparatus in a closed position.

FIG. 9 is a top profile view of a battery module retention apparatus according to embodiments of the disclosure and illustrates insertion of the battery module into the battery module retention apparatus.

FIG. 10 is a flow chart illustrating a method for releasably securing a battery module using a battery module retention apparatus having a first arm according to embodiments of the disclosure.

FIG. 11 is a flow chart illustrating a method for releasably securing a battery module using a battery module retention apparatus having first and second arms according to embodiments of the disclosure.

FIG. 12 is a schematic block diagram of an example information handling system according to some embodiments of the disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

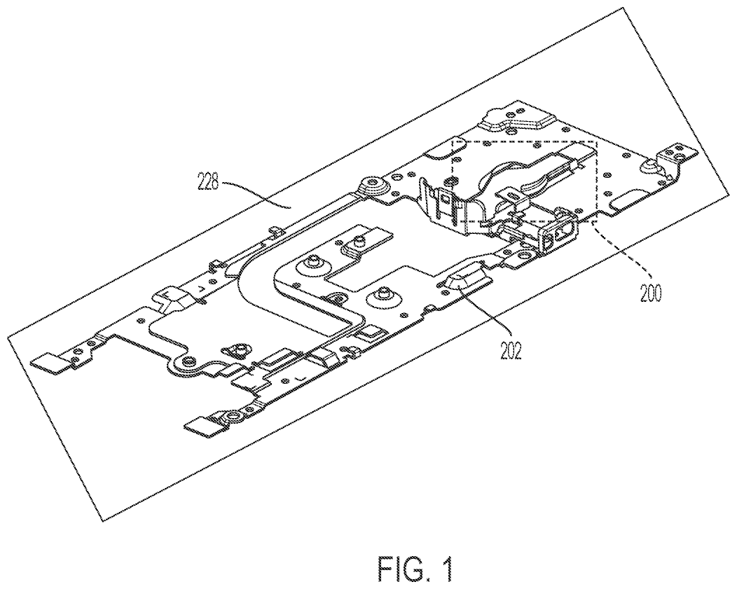

The functions performed by the IHS are carried out once the IHS booting process is complete. The booting process is controlled by code stored in a complementary metal-oxide-semiconductor (CMOS) memory on the mainboard, which may also be used to store basic input/output system (BIOS) settings relating to hardware initialization during the booting process. The CMOS memory can be powered by a coin-cell battery, sometimes referred to as a CMOS battery, that is connected to the mainboard to keep the contents available while main power is disconnected. Alternatively, to save space on the mainboard, the CMOS memory can be powered by a RTC battery and cable assembly. The battery module, whether a coin-cell battery or a RTC battery and cable assembly, may be mechanically secured within the IHS, such as between the mainboard and a surface on which the mainboard is mounted. In some embodiments of the disclosed invention, the battery module may be mechanically secured to the surface by a retention apparatus comprising a flexible arm formed as a feature of the surface. This flexible arm can be manipulated between an open and closed position to allow coupling of the battery module to the surface. In these embodiments, the battery module is releasably secured to the surface, which can make the manufacturing and/or servicing of an IHS easier and faster. One example embodiment of such a battery module retention apparatus is shown in FIG. 1. In various embodiments described and illustrated herein, a battery module retention apparatus may be included on a mainboard of an IHS and the mainboard installed in a chassis such that the battery module is retained between the mainboard and the chassis through the flexible arm integrated with the mainboard. However, other embodiments may integrate the flexible arm and other features into other components within the IHS and be installed in a chassis such that the other components retain the battery between the component and the chassis. In still further embodiments, the battery module retention apparatus may be a separate component installed in the IHS such that the battery module is retained between the battery module retention apparatus and the chassis. In other embodiments, the battery module retention apparatus is configured as a standalone apparatus or integrated into another component and installed in the IHS to retain a battery module against a surface other than the chassis. In still further embodiments, the retention apparatus is configured, such as through different size features, to retain other components in a secure position.

FIG. 1 is a top profile view of a mainboard 228 mounted to a surface 202 such as a backplane or other mainboard having a battery module retention apparatus 200 according to embodiments of the disclosure. The surface 202 may have a bracket for mounting of the mainboard 228 to which battery module 206 connects. The battery module retention apparatus 200 may be integrally connected to surface 202 such that battery module retention apparatus 200 and surface 202 comprise a single piece of material, e.g., sheet metal or plastic. Alternatively, the battery module retention apparatus 200 may be a separate component attached to other components within the information handling system or the surface 202 of the information handling system and may be configured to retain the battery module by securing the battery module to another component of the information handling system.

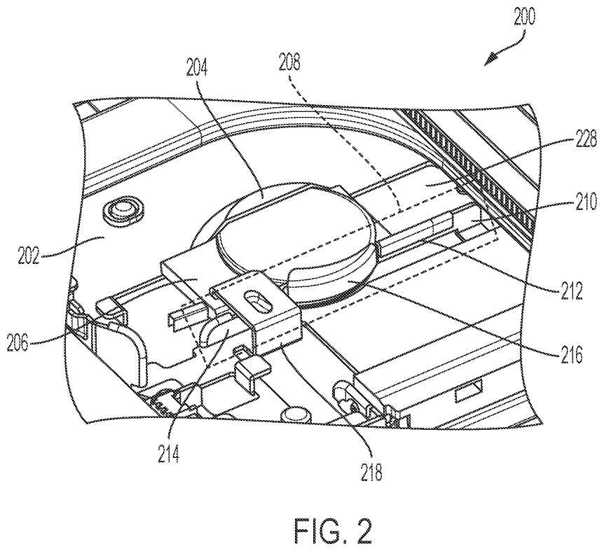

Embodiments of the battery module retention apparatus 200 of FIG. 1 is shown in more detail in FIGS. 2-8. FIG. 2 is a top profile view of a battery module retention apparatus 200 according to embodiments of the disclosure. The surface 202 may comprise at least one wall 204, such as greater than or equal to any one of, or between any two of, 1, 2, 3, 4, 5, 6, 7, 8, 9, 10, 11, 12, or more walls. For example, in the embodiment shown, the surface 202 comprises one wall 204. As shown, wall 204 may be arcuate, e.g., circular, elliptical, parabolic, or hyperbolic. Wall 204 can have other configurations, however. For example, in other embodiments, wall 204 may be polygonal and may comprise straight line segments, e.g., greater than or equal to any one of, or between any two of, 1, 2, 3, 4, 5, 6, 7, 8, 9, 10, 11, 12, or more line segments.

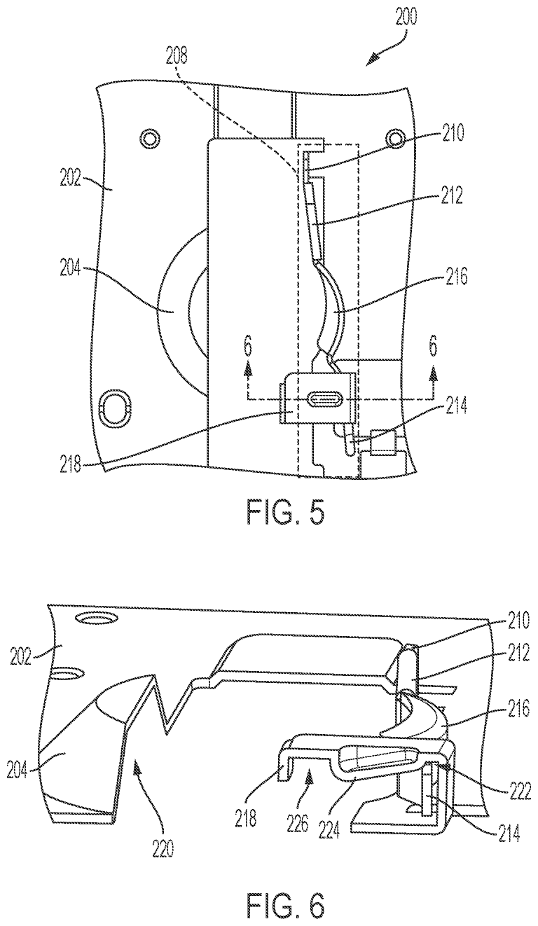

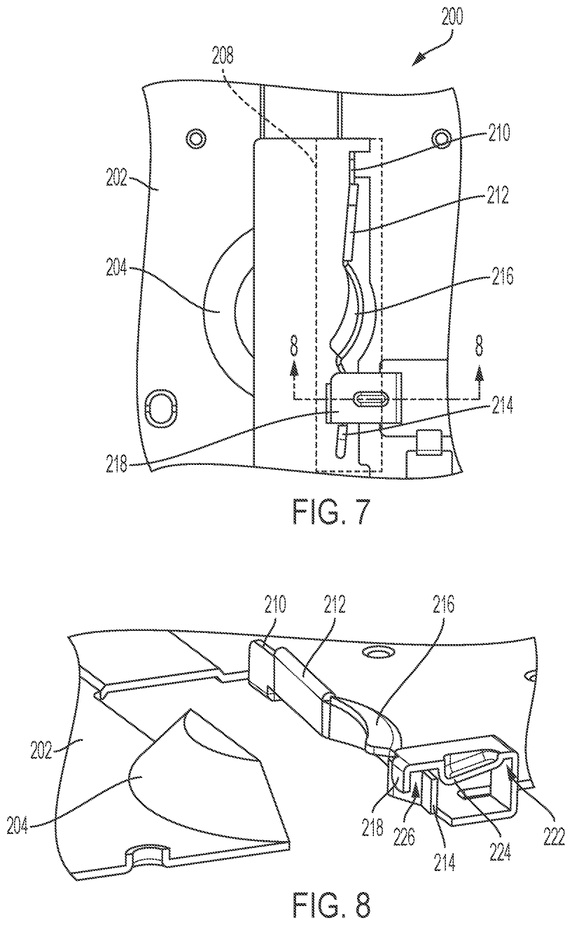

The surface 202 may further comprise a first arm 208. First arm 208 may be configured to secure battery module 206 between two components: a first component integrated with battery module retention apparatus 200 (e.g., surface 202 having wall 204), and a second component that provides a retaining surface opposite the first integrated component (e.g., the same surface 202 or another surface, e.g., mainboard 228). For example, in the embodiment illustrated by FIGS. 5-7, first arm 208 is moveable relative to wall 204 between an open position in which battery module 206 can be received by surface 202 (FIGS. 5 and 6) and a closed position in which battery module 206 can be secured between surface 202 and mainboard 228 (FIGS. 7 and 8).

The first arm may have a first end 212, a second end 214, and a middle portion 216 between the first end 212 and second end 214. The first end 212, in some embodiments, hingedly couples first arm 208 to surface 202. The second end 214 of first arm 208 may be configured to be manipulated by a user to transition the first arm between the open position and the closed position. The middle portion 216 may be configured to retain battery module 206. Middle portion 216 of first arm 208 may be configured to retain battery module 206 such that first arm 208 overlies at least a portion of battery module 206 when first arm 208 is in the closed position and battery module 206 is secured between a first component integrated with battery module retention apparatus 200 and a second component that provides a retaining surface opposite the first integrated component (e.g., between surface 202 and IHS mainboard 228). For example, first arm 208 may overlie greater than or equal to any one of, or between any two of, 10%, 20%, 30%, 40%, 50%, 60%, 70%, 80%, 90%, or 100% of battery module 206 when first arm 208 is in the closed position and battery module 206 is secured between a first component integrated with battery module retention apparatus 200 and a second component that provides a retaining surface opposite the first integrated component (e.g., between surface 202 and IHS mainboard 228). As shown, middle portion 216 may be arcuate, e.g., circular, elliptical, parabolic, or hyperbolic. Middle portion 216 can have other configurations, however. For example, in other embodiments, middle portion 216 may be polygonal and may comprise straight line segments, e.g., greater than or equal to any one of, or between any two of, 1, 2, 3, 4, 5, 6, 7, 8, 9, 10, 11, 12, or more line segments.

A hinge 210 may couple the first arm 208 and surface 202. Hinge 210 may flexibly connect surface 202 to first end 212 of first arm 208. Hinge 210 may be a living hinge that is integrally and homogeneously made of the same material, e.g., sheet metal or plastic, as surface 202 and may be created during manufacturing of surface 202. Hinge 210 may also facilitate lateral movement of first arm 208 relative to wall 204 between the open position and the closed position.

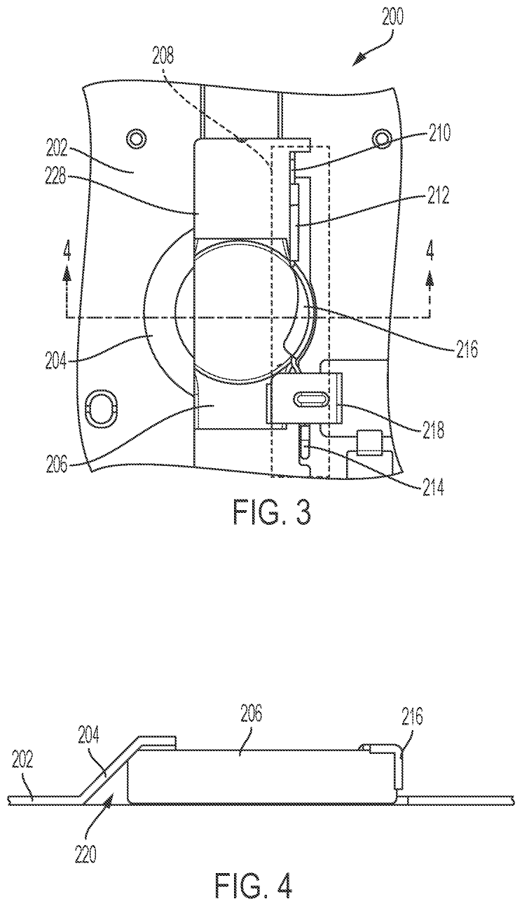

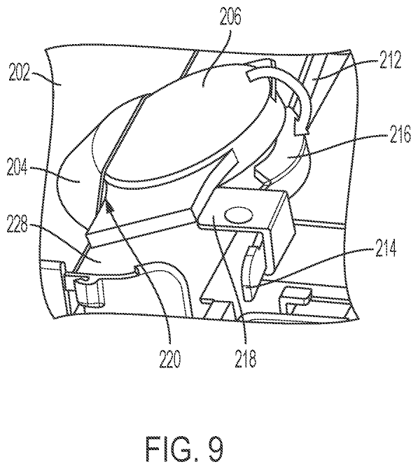

As best seen in FIGS. 4 and 6, wall 204 of body 202 may define a cavity 220. Cavity 220 may be configured to receive battery module 206 such that wall 204 overlies at least a portion of battery module 206 when battery module 206 is received in the cavity 220. For example, cavity 220 may overlie greater than or equal to any one of, or between any two of, 10%, 20%, 30%, 40%, 50%, 60%, 70%, 80%, 90%, or 100% of battery module 206 when battery module 206 is received in the cavity 220. First arm 208 may be positioned opposite cavity 220. In some embodiments, first arm 208 is configured to releasably secure battery module 206 in cavity 220 such that battery module 206 is releasably secured between a first component integrated with battery module retention apparatus 200 and a second component that provides a retaining surface opposite the first integrated component (e.g., between surface 202 and IHS mainboard 228). For example, first arm 208 may be movable between an open position in which a distance between first arm 208 and cavity 220 is larger than a distance between first arm 208 and cavity 220 when first arm 208 is in a closed position in which battery module 206 is secured in cavity 200. In some embodiments, first arm 208 is movable between an open position in which battery module 206 is received by cavity 220 (FIG. 9) and a closed position in which battery module 206 is secured in cavity 220 (FIGS. 3 and 4). In some embodiments, first arm 208 is movable relative to wall 204 between an open position and a closed position. In some embodiments, wall 204 is opposite a surface (e.g., surface 202 or another surface, e.g., mainboard 228), or cavity 220 is defined on one side by an opposing surface (e.g., surface 202 or another surface, e.g., mainboard 228), such that the securing is between wall 204 and the opposing surface.

First arm 208 can be biased toward the closed position in which battery module 206 is secured in cavity 220 between a first component integrated with battery module retention apparatus 200 and a second component that provides a retaining surface opposite the first integrated component (e.g., between surface 202 and IHS mainboard 228). For example, a resting position of first arm 208, in which no force is applied by a user, may be parallel with or biased toward wall 204. Body 202 may be further configured to maintain first arm 208 in the open position when first arm 208 is biased toward the closed position. For example, body 202 may further comprise a second arm 218 opposite wall 204 and cavity 220. Like first arm 208, second arm 218 may be integrally and homogeneously made of the same material, e.g., sheet metal or plastic, as surface 202 and may be created during manufacturing of surface 202.

Second arm 218 may be configured to engage and/or retain second end 214 of first arm 208 such that first arm 208 is maintained in the open position, as shown in FIGS. 5 and 6. Second arm 218 may also be configured to engage and/or retain second end 214 of first arm 208 in the closed position, as shown in FIGS. 7 and 8. Second arm 218 may also be configured to prevent over-biasing of first arm 208 toward wall 204 when first arm 208 is in the closed position, which may prevent damage to surface 202 due to, e.g., hyperflexion of surface 202 material.

As shown in FIG. 6, second arm 218 may define at least two recesses, such as greater than or equal to any one of, or between any two of, 2, 3, 4, 5, 6, 7, 8, 9, 10, 11, 12, or more recesses, to facilitate engagement and/or retention of second end 214 of first arm 208 in an open or closed position. For example, in the embodiment shown, second arm 218 comprises first recess 222 and second recess 226. Second end 214 of first arm 208 may be received in first recess 222 of second arm 218 when first arm 208 is in the open position. Second end 214 of first arm 208 may be received in second recess 226 when first arm 208 is in the closed position.

The recesses of second arm 218 may be separated by at least one protrusion 224, such as greater than or equal to any one of, or between any two of, 1, 2, 3, 4, 5, 6, 7, 8, 9, 10, 11, 12, or more protrusions. For example, in the embodiment shown, first recess 222 and second recess 226 are separated by one protrusion 224. Protrusion 224 may define a ramp such that protrusion 224 has a slope that is angularly disposed relative to second recess 226 by an angle such that the depth of the first recess 222 increases moving away from second recess 226. The angle can be greater than or equal to any one of, or between any two of, 5°, 10°, 20°, 30°, 40°, 50°, 60°, 70°, or 80° (e.g., between 20° and 40°), as measured relative to a direction parallel to the centerline of second recess 226. As shown in FIG. 6, protrusion 224 is defined by a single, planar surface. In other embodiments, however, protrusion 224 may be defined by a plurality of steps having a rise and run such that the ramp has any of the above-described slopes.

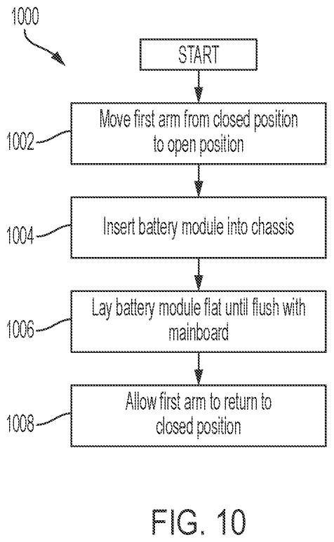

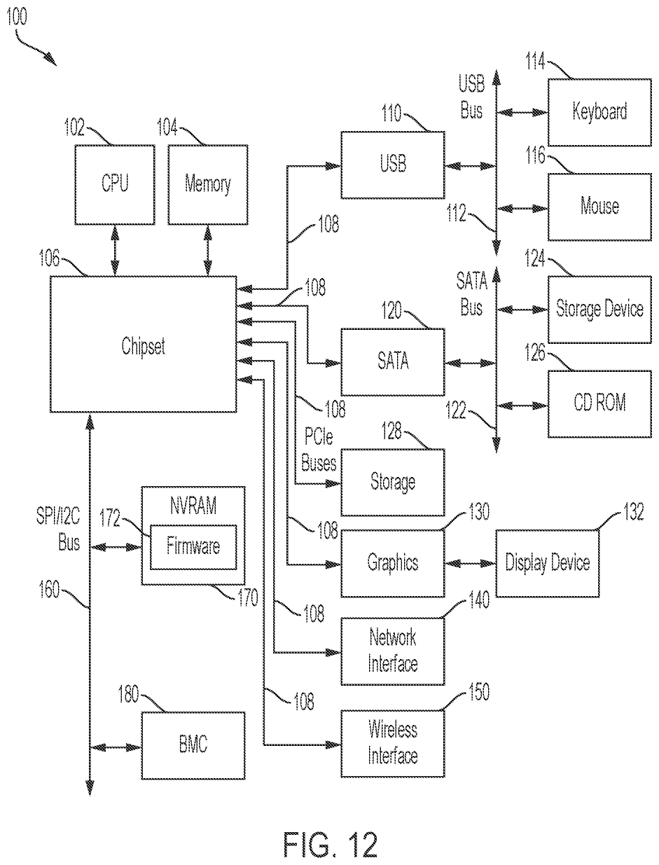

A method for installing a battery module (e.g., 206) into a battery module retention apparatus (e.g., 200) is shown in FIG. 10. FIG. 10 is a flow chart illustrating a method for assembling an information handling system (e.g., any of those described herein) having a battery module and a battery module retention apparatus. To assemble an information handling system having a mainboard (e.g., a board comprising one or more of the components shown in FIG. 12), a surface (e.g., 202), a battery module, and a battery module retention apparatus, a method 1000 may comprise releasably securing the battery module between a first component integrated with the battery module retention apparatus and a second component that provides a retaining surface opposite the first integrated component (e.g., between surface 202 and IHS mainboard 228) using the battery module retention apparatus.

As described above and as shown at block 1002, insertion of the battery module into the battery module retention apparatus is facilitated by moving a first arm (e.g., 208) of the battery module retention apparatus relative to a wall (e.g., 204) of the surface from a closed position into an open position. Movement of the first arm may lateral, and in some embodiments, movement of the first arm is lateral relative to the wall. FIG. 5 is a top view of the battery module retention apparatus according to embodiments of the disclosure and illustrates the first arm of the battery module retention apparatus in the open position at block 1002. FIG. 6 is a cross-sectional view of the FIG. 5 battery module retention apparatus taken along line 6-6 of FIG. 5 and illustrates the first arm of the battery module retention apparatus in the open position at block 1002. Movement of the first arm into the open position may be facilitated by a hinge (e.g., 210) coupled to the first arm and the surface, which may be a living hinge as described above.

At block 1004, once the battery module retention apparatus is in the open position, the battery module is inserted between a first component integrated with battery module retention apparatus and a second component that provides a retaining surface opposite the first integrated component (e.g., between the surface and IHS mainboard). FIG. 9 is a top profile view of the battery module retention apparatus according to embodiments of the disclosure and illustrates insertion of the battery module into the battery module retention apparatus at block 1004. As shown in FIG. 9, the battery module can be inserted into a cavity (e.g., 220) defined by the wall of the body. The cavity is configured to receive one side of the battery module such that the wall overlies at least a portion of battery module when battery module is received in the cavity. Covering of at least a portion of the battery module by the wall may facilitate securement of the battery module between the surface and the mainboard of the IHS.

At block 1006, the side of the battery module opposite the side received in the cavity is then laid flat such that the battery module is flush with the retaining surface opposite the first integrated component of the battery module retention apparatus (e.g., flush with a mainboard bracketed to the surface). In this embodiment, the side of the battery module opposite the side received in the cavity is placed in position for contact with and retention by the middle portion of the first arm of the battery module retention apparatus.

At block 1008, once the battery module laid flat, the first arm is allowed to return to a closed position. Movement of the first arm into the closed position may also be facilitated by the hinge. FIG. 7 is a top view of a battery module retention apparatus according to embodiments of the disclosure and illustrates the first arm of the battery module retention apparatus in the closed position at block 1008. FIG. 8 is a cross-sectional view of the FIG. 7 battery module retention apparatus taken along line 8-8 of FIG. 7 and illustrates the first arm of the battery module retention apparatus in the closed position at block 1008. A middle portion (e.g., 216) of the first arm of the battery module retention apparatus may contact the perimeter of the battery module when the first arm is in the closed position. The middle portion of the first arm may contact the battery module such that the first arm overlies at least a portion of the battery module when the first arm is in the closed position. Covering of at least a portion of the battery module by the middle portion of the first arm may also facilitate securement of the battery module between a first component integrated with battery module retention apparatus and a second component that provides a retaining surface opposite the first integrated component (e.g., between the surface and IHS mainboard). FIG. 3 is a top view of a battery module retention apparatus having a battery module secured therein according to embodiments of the disclosure and illustrates covering of at least a portion of the battery module by the wall and the middle portion of the first arm. FIG. 4 is a sectional view of the FIG. 3 battery module retention apparatus taken along line 4-4 of FIG. 3 and illustrates securement of battery module by the battery module retention apparatus.

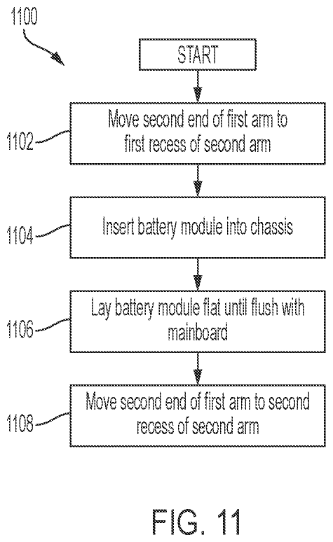

In some methods for installing a battery module into a battery module retention apparatus, the first arm of the battery module retention apparatus may be biased toward the closed position such that, in the absence of application of force by a user to manipulate the first arm, the first arm is parallel with or biased toward the wall of the apparatus. Thus, another method for installing a battery module into a battery module retention apparatus according to embodiments of the disclosure is described with reference to FIG. 11. To assemble an information handling system having a battery module and a battery module retention apparatus, a method 1100 may comprise releasably securing the battery module between a first component integrated with battery module retention apparatus and a second component that provides a retaining surface opposite the first integrated component (e.g., between the surface and IHS mainboard) using a battery module retention apparatus having a first and second arm.

The battery module retention apparatus may further comprise a second arm opposite the wall and cavity of the apparatus for engaging the first arm and/or retaining the first arm in the open position, as described above. At block 1102, moving the first arm of the battery module retention apparatus relative to the wall of the surface from a closed position into an open position can comprise moving a second end (e.g., 214) of the first arm from a second recess (e.g., 226) defined by the second arm over a protrusion (e.g., 224) defined by the second arm (e.g., 218) and into a first recess (e.g., 222) defined by the second arm. The second end of the first arm is received by the first recess such that the first arm remains engaged and/or retained in the open position in the absence of any application of force by a user. FIG. 5 is a top view of the battery module retention apparatus according to embodiments of the disclosure and illustrates receipt of the second end of the first arm of the battery module retention apparatus in the first recess of the second arm to engage and/or retain the first arm of the battery module retention apparatus in the open position at block 1102. FIG. 6 is a cross-sectional view of the FIG. 5 battery module retention apparatus taken along line 6-6 of FIG. 5 and illustrates receipt of the second end of the first arm of the battery module retention apparatus in the first recess of the second arm to engage and/or retain the first arm of the battery module retention apparatus in the open position at block 1102. Movement of the first arm from the second recess of the second arm, over the protrusion of the second arm, and into the first recess of the second arm to engage and/or retain the first arm of the battery module retention apparatus in the open position may be facilitated by the hinge coupled to the first arm and the surface, which may be a living hinge as described above.

At block 1104, once the first arm of the battery module retention apparatus in engaged and/or retained by the second arm in the open position, the battery module is inserted into the surface. FIG. 9 is a top profile view of the battery module retention apparatus according to embodiments of the disclosure and illustrates insertion of the battery module into the battery module retention apparatus at block 1104. As shown in FIG. 9, the battery module can be inserted into the cavity defined by the wall of the surface. The cavity is configured to receive one side of the battery module such that the wall overlies at least a portion of battery module when battery module is received in the cavity. Covering of at least a portion of the battery module by the wall may facilitate securement of the battery module between a first component integrated with battery module retention apparatus and a second component that provides a retaining surface opposite the first integrated component (e.g., between the surface and IHS mainboard).

At block 1106, the side of the battery module opposite the side received in the cavity is then laid flat such that the battery module is flush with the retaining surface opposite the first integrated component of the battery module retention apparatus (e.g., flush with a mainboard bracketed to the surface). In this embodiment, the side of the battery module opposite the side received in the cavity is placed in position for contact with and retention by the middle portion of the first arm of the battery module retention apparatus.

At block 1108, once the battery module is laid flat, the first arm is moved to a closed position. Moving the first arm of the battery module retention apparatus relative to the wall of the surface into a closed position can comprise moving the second end of the first arm from the first recess defined by the second arm over the protrusion defined by the second arm and into the second recess defined by the second arm. The second end of the first arm is received by the second recess such that the first arm remains engaged and/or retained in the closed position in the absence of any application of force by a user. Movement of the first arm from the first recess of the second arm, over the protrusion of the second arm, and into the second recess of the second arm to engage and/or retain the first arm of the battery module retention apparatus in the closed position may be facilitated by the hinge coupled to the first arm and the surface, which may be a living hinge as described above. FIG. 7 is a top view of a battery module retention apparatus according to embodiments of the disclosure and illustrates the first arm of the battery module retention apparatus in the closed position at block 1108. FIG. 8 is a cross-sectional view of the FIG. 7 battery module retention apparatus taken along line 8-8 of FIG. 7 and illustrates the first arm of the battery module retention apparatus in the closed position at block 1108.

Some methods of releasably securing a battery module using a battery module apparatus may further comprise removal of the battery module from the battery module apparatus of the information handling system. In embodiments in which the battery module is removed, the step at block 1002 of FIG. 10 or the step at block 1102 is repeated to move the first arm of the battery module retention apparatus from a closed position into an open position. Then, the side of the battery module opposite the side received in the cavity of the battery module retention apparatus is lifted until the battery module is no longer in contact with the middle portion of the first arm of the battery module retention apparatus. Finally, the side of the battery module received by the cavity is removed from the cavity to release the battery module from the battery module retention apparatus. In this manner, a battery module of the IHS may be removed, for example, for replacement or other service.

These example embodiments describe and illustrate various mechanisms for releasably securing a battery module that may be used to power at least a portion of an information handling system, of which one embodiment is illustrated in FIG. 12. In some embodiments, the battery module may power a CMOS memory as part of a BIOS system (e.g., a Unified Extensible Firmware Interface) for the information handling system. In some embodiments, the battery module may power the information handling system, such as when the battery module is a laptop battery. An information handling system may include a variety of components to generate, process, display, manipulate, transmit, and receive information. One example of an information handling system 100 is shown in FIG. 12.

FIG. 12 illustrates an example information handling system 100.

Information handling system 100 may include a processor 102 (e.g., a central processing unit (CPU)), a memory (e.g., a dynamic random-access memory (DRAM)) 104, and a chipset 106. In some embodiments, one or more of the processor 102, the memory 104, and the chipset 106 may be included on a motherboard (also referred to as a mainboard), which is a printed circuit board (PCB) with embedded conductors organized as transmission lines between the processor 102, the memory 104, the chipset 106, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 102, the memory 104, the chipset 106, and/or other components may be organized as a System on Chip (SoC)

The processor 102 may execute program code by accessing instructions loaded into memory 104 from a storage device, executing the instructions to operate on data also loaded into memory 104 from a storage device, and generate output data that is stored back into memory 104 or sent to another component. The processor 102 may include processing cores capable of implementing any of a variety of instruction set architectures (ISAs), such as the ×86, POWERPC®, ARM®, SPARC®, or MIPS® ISAs, or any other suitable ISA. In multi-processor systems, each of the processors 102 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 106 may facilitate the transfer of data between the processor 102, the memory 104, and other components. In some embodiments, chipset 106 may include two or more integrated circuits (ICs), such as a northbridge controller coupled to the processor 102, the memory 104, and a southbridge controller, with the southbridge controller coupled to the other components such as USB 110, SATA 120, and PCIe buses 108. The chipset 106 may couple to other components through one or more PCIe buses 108.

Some components may be coupled to one bus line of the PCIe buses 108, whereas some components may be coupled to more than one bus line of the PCIe buses 108. One example component is a universal serial bus (USB) controller 110, which interfaces the chipset 106 to a USB bus 112. A USB bus 112 may couple input/output components such as a keyboard 114 and a mouse 116, but also other components such as USB flash drives, or another information handling system. Another example component is a SATA bus controller 120, which couples the chipset 106 to a SATA bus 122. The SATA bus 122 may facilitate efficient transfer of data between the chipset 106 and components coupled to the chipset 106 and a storage device 124 (e.g., a hard disk drive (HDD) or solid-state disk drive (SDD)) and/or a compact disc read-only memory (CD-ROM) 126. The PCIe bus 108 may also couple the chipset 106 directly to a storage device 128 (e.g., a solid-state disk drive (SDD)). A further example of an example component is a graphics device 130 (e.g., a graphics processing unit (GPU)) for generating output to a display device 132, a network interface controller (NIC) 140, and/or a wireless interface 150 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces). In one example embodiment, chipset 106 may be directly connected to an individual end point via a PCIe root port within the chipset and a point-to-point topology as shown in FIG. 1.

The chipset 106 may also be coupled to a serial peripheral interface (SPI) and/or Inter-Integrated Circuit (I2C) bus 160, which couples the chipset 106 to system management components. For example, a non-volatile random-access memory (NVRAM) 170 for storing firmware 172 may be coupled to the bus 160. As another example, a controller, such as a baseboard management controller (BMC) 180, may be coupled to the chipset 106 through the bus 160. BMC 180 may be referred to as a service processor or embedded controller (EC). Capabilities and functions provided by BMC 180 may vary considerably based on the type of information handling system. For example, the term baseboard management system may be used to describe an embedded processor included at a server, while an embedded controller may be found in a consumer-level device. As disclosed herein, BMC 180 represents a processing device different from processor 102, which provides various management functions for information handling system 100. For example, an embedded controller may be responsible for power management, cooling management, and the like. An embedded controller included at a data storage system may be referred to as a storage enclosure processor or a chassis processor.

System 100 may include additional processors that are configured to provide localized or specific control functions, such as a battery management controller. Bus 160 can include one or more busses, including a Serial Peripheral Interface (SPI) bus, an Inter-Integrated Circuit (I2C) bus, a system management bus (SMBUS), a power management bus (PMBUS), or the like. BMC 180 may be configured to provide out-of-band access to devices at information handling system 100. Out-of-band access in the context of the bus 160 may refer to operations performed prior to execution of firmware 172 by processor 102 to initialize operation of system 100.

Firmware 172 may include instructions executable by processor 102 to initialize and test the hardware components of system 100. For example, the instructions may cause the processor 102 to execute a power-on self-test (POST). The instructions may further cause the processor 102 to load a boot loader or an operating system (OS) from a mass storage device. Firmware 172 additionally may provide an abstraction layer for the hardware, such as a consistent way for application programs and operating systems to interact with the keyboard, display, and other input/output devices. When power is first applied to information handling system 100, the system may begin a sequence of initialization procedures, such as a boot procedure or a secure boot procedure. During the initialization sequence, also referred to as a boot sequence, components of system 100 may be configured and enabled for operation and device drivers may be installed. Device drivers may provide an interface through which other components of the system 100 can communicate with a corresponding device. The firmware 172 may include a basic input-output system (BIOS) and/or include a unified extensible firmware interface (UEFI). Firmware 172 may also include one or more firmware modules of the information handling system. Additionally, configuration settings for the firmware 172 and firmware of the information handling system 100 may be stored in the NVRAM 170. NVRAM 170 may, for example, be a non-volatile firmware memory of the information handling system 100 and may store a firmware memory map namespace 100 of the information handling system. NVRAM 170 may further store one or more container-specific firmware memory map namespaces for one or more containers concurrently executed by the information handling system.

Information handling system 100 may include additional components and additional busses, not shown for clarity. For example, system 100 may include multiple processor cores (either within processor 102 or separately coupled to the chipset 106 or through the PCIe buses 108), audio devices (such as may be coupled to the chipset 106 through one of the PCIe busses 108), or the like. While a particular arrangement of bus technologies and interconnections is illustrated for the purpose of example, one of skill will appreciate that the techniques disclosed herein are applicable to other system architectures. System 100 may include multiple processors and/or redundant bus controllers. In some embodiments, one or more components may be integrated together in an integrated circuit (IC), which is circuitry built on a common substrate. For example, portions of chipset 106 can be integrated within processor 102. Additional components of information handling system 100 may include one or more storage devices that may store machine-executable code, one or more communications ports for communicating with external devices, and various input and output (I/O) devices, such as a keyboard, a mouse, and a video display.

In some embodiments, processor 102 may include multiple processors, such as multiple processing cores for parallel processing by the information handling system 100. For example, the information handling system 100 may include a server comprising multiple processors for parallel processing. In some embodiments, the information handling system 100 may support virtual machine (VM) operation, with multiple virtualized instances of one or more operating systems executed in parallel by the information handling system 100. For example, resources, such as processors or processing cores of the information handling system may be assigned to multiple containerized instances of one or more operating systems of the information handling system 100 executed in parallel. A container may, for example, be a virtual machine executed by the information handling system 100 for execution of an instance of an operating system by the information handling system 100. Thus, for example, multiple users may remotely connect to the information handling system 100, such as in a cloud computing configuration, to utilize resources of the information handling system 100, such as memory, processors, and other hardware, firmware, and software capabilities of the information handling system 100. Parallel execution of multiple containers by the information handling system 100 may allow the information handling system 100 to execute tasks for multiple users in parallel secure virtual environments.

The schematic flow chart diagram of FIGS. 10 and 11 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus, comprising:
a surface having at least one wall that defines a cavity configured to receive a battery module such that the wall overlies at least a portion of the battery module when the battery module is received in the cavity; and
a first arm opposite the cavity configured to releasably secure the battery module in the cavity, the first arm being movable between an open position in which a distance between the first arm and the cavity is larger than a distance between the first arm and the cavity when the first arm is in a closed position in which the battery module is secured in the cavity,
wherein the first arm is connected to the surface via a living hinge.

2. The apparatus of claim 1, wherein the first arm has a first end, a second end, and a middle portion between the first end and second end, and wherein:
the first end hingedly couples the first arm to the surface;
the middle portion is configured to retain the battery module; and
the second end is configured to be manipulated by a user to transition the first arm between the open position and the closed position.

3. The apparatus of claim 2, wherein the middle portion of the first arm is configured to retain the battery module such that the first arm overlies at least a portion of the battery module when the first arm is in the closed position.

4. The apparatus of claim 2, wherein the middle portion of the first arm is arcuate.

5. The apparatus of claim 1, wherein the first arm is biased toward the closed position.

6. The apparatus of claim 1, wherein the surface is configured to maintain the first arm in the open position.

7. The apparatus of claim 6, wherein the surface further comprises a second arm opposite the cavity configured to engage and/or retain the second end of the first arm.

8. The apparatus of claim 7, wherein the second arm is integrally connected to the surface.

9. The apparatus of claim 7, wherein the second arm defines at least a first recess and a second recess, and wherein the at least first recess and second recess are separated by at least one protrusion.

10. The apparatus of claim 9, wherein the at least one protrusion defines a ramp.

11. The apparatus of claim 9, wherein:
the second end of the first arm is received in the first recess when the first arm is in the open position; and
the second end of the first arm is received in the second recess when the first arm is in the closed position.

12. The apparatus of claim 1, wherein the first arm is laterally moveable relative to the wall between the open position and the closed position.

13. A method of assembling an information handling system comprising a battery module and a battery module retention apparatus comprising releasably securing the battery module using the battery module retention apparatus by:
moving a first arm of the battery module retention apparatus away from a cavity opposite the first arm into an open position using a living hinge connecting the first arm to a surface of the battery module retention apparatus;
inserting the battery module into the cavity; and
allowing the first arm to return to a closed position using the living hinge to secure the battery module against a surface of the information handling system.

14. The method of claim 13, wherein the first arm is biased toward the closed position.

15. The method of claim 13, wherein the surface is configured to maintain the first arm in the open position.

16. The method of claim 15, wherein the surface further comprises a second arm opposite the cavity for engaging and/or retaining the second end of the first arm.

17. The method of claim 16, wherein:
the second arm defines at least a first and second recess separated by at least one protrusion;
the first recess receives the second end of the first arm when the first arm is in the open position; and
the second recess receives the second end of the first arm when the first arm is in the closed position.

18. The method of claim 17, further comprising:
moving the first arm into the open position by moving the second end of the first arm from the second recess over the protrusion such that the second end of the first arm is received by first recess; and
moving the first arm into the closed position by moving the second end of the first arm from the first recess over the protrusion such that the second end of the first arm is received by second recess.

19. The method of claim 13, comprising moving the first arm laterally relative to the wall between the open position and the closed position.

20. An information handling system, comprising:
a mainboard;
a surface coupled to the mainboard;
a battery module secured between the mainboard and surface; and
a battery module retention apparatus for securement of the battery between the mainboard and the surface, comprising:
a surface having at least one wall that defines a cavity configured to receive a battery module such that the wall overlies at least a portion of the battery module when the battery module is received in the cavity; and
a first arm opposite the cavity configured to releasably secure the battery module in the cavity, the first arm being movable between an open position in which a distance between the first arm and the cavity is larger than a distance between the first arm and the cavity when the first arm is in a closed position in which the battery module is secured in the cavity, wherein the first arm is connected to the surface via a living hinge.
